(19) United States
(12) Patent Application Publication
(10) Pub. No.: US 2003/0210673 A1
(43) Pub. Date: Nov. 13, 2003

(54) Radio communication system realizing extended MPDU format having large number of data bytes

(75) Inventor: Takuya Nishimura, Fukushima-ken (JP)

Correspondence Address: Brinks Hofer Gilson & Lione, P.O. Box 10395, Chicago, IL, 60610, US

(73) Assignee: ALPS ELECTRIC CO., LDT.

(21) Appl. No.: 10/430,564

(22) Filed: May 6, 2003

(30) Foreign Application Priority Data
May 7, 2002 (JP) 2002-131725

(51) Int. Cl. H04Q 7/24

(52) U.S. Cl. 370/338; 370/328; 370/463

(57) ABSTRACT

In accordance with a network protocol having an IP layer, a MAC layer and a physical layer, an MPDU formed in the physical layer is transmitted through a LAN by radio transmission between a transmitting-side transmission terminal and a receiving-side transmission terminal among a large number of transmission terminals. When a part of the transmission terminals, using the extended network protocol where an extended MPDU having a data amount larger than a data amount standardized in the network protocol can be formed, is a transmitting-side transmission terminal, if it is determined through the LAN that a receiving-side transmission terminal is applicable to the extended network protocol, the transmitting-side transmission terminal forms an extended MPDU in the physical layer in accordance with the extended network protocol, and transmits the extended MPDU through the LAN to the receiving-side transmission terminal by radio transmission.

### BACKGROUND OF THE INVENTION

1. Field of the Invention

The present invention relates to a radio transmission system, and more particularly, to a radio transmission system for selectively transmitting a MAC protocol data unit (hereinbelow, MPDU) or an extended MAC protocol data unit (hereinbelow, extended MPDU) by time-division radio transmission, between two transmission terminals among a large number of transmission terminals connected via a local area network (hereinbelow, LAN).

2. Description of the Related Art

Conventionally, in a radio LAN where data radio transmission is performed through the LAN between selectively-connected two transmission terminals among a large number of transmission terminals, a transmittable data amount in one data transmission is limited, and if data of an amount larger than the limited data amount is transmitted, the data is divided into two or more data pieces, and sequentially transmitted in two or more times of transmission.

FIG. 10 is an explanatory view showing an example of structure of a well-known three-layer network protocol used in a radio transmission system using a LAN. The network protocol is a Transmission Control Protocol/Internet Procotol (TCP/IP) which is a general communication protocol.

As shown in FIG. 10, the network protocol has an IP (Internet Protocol) layer as a third layer, a MAC (Media Access Control) layer as a second layer, and a physical layer as a first layer. The IP layer handles an IP packet including an IP header and a data area. The MAC layer handles a MAC packet including a MAC header, the IP packet and an FCS (Frame Check Sequence). The physical layer handles packet data including a preamble pattern, a PLCP header, an MPDU (MAC protocol data unit) having the MAC packet, tail bits, and pad bits. In the radio transmission system, packet data in the physical layer is transmitted through the LAN between a transmitting-side transmission terminal and a receiving-side transmission terminal.

In the well-known radio transmission system using a LAN, CSMA/CD (Carrier Sense Multiple Access/Collision Detection) as IEEE 802.11 communication is performed. When the transmitting-side transmission terminal has transmitted one packet data piece, the terminal must wait before transmission of the next packet data for a period of DIFS (in the case of IEEE 802.11a, 34 μs) and a back-off period (in the case of IEEE 802.11a, 15 to 1023×9 μs). If packet data transmission is performed from another transmitting-side transmission terminal during the waiting period, the transmission of the next packet data by the initial transmitting-side transmission terminal is further delayed, and in some cases, trouble occurs in data processing in the receiving-side transmission terminal.

One of techniques of avoiding the delay of packet data transmission in the transmitting-side transmission terminal is to set a data length of one packet data piece to a longer length than a standardized data length during a period where a transmission status of the LAN is good. By this arrangement, a transmission rate is improved by the increment of data length, and as a result, the delay of packet data transmission can be avoided.

However, as the maximum data length of IP packet in the IP layer of the general TCP/IP is 1500 bytes while the maximum number of data bytes of an MPDU of packet data is 1500, the number of data bytes cannot be increased, and the delay of packet data transmission cannot be avoided.

On the other hand, according to an IEEE 802.11 system, the maximum number of data bytes of a MAC packet in the MAC layer is 2313, and according to an IEEE 802.11a system, the maximum number of data bytes of an MPDU of packet data in the physical layer is 4095, both of which are larger than the maximum number of data bytes of an MPDU of packet data in the TCP/IP.

### SUMMARY OF THE INVENTION

The present invention has been made in consideration of the above technical background, and has its object to provide a radio transmission system using an extended network protocol for transmission between transmission terminals, which enables formation of an extended MPDU (extended MAC protocol data unit) having a data amount larger than the standardized data amount of the network protocol.

According to the present invention, the foregoing object is attained by providing a radio transmission system in accordance with a network protocol forming an IP layer handling an IP packet, a MAC layer handling a MAC packet including the IP packet, and a physical layer having a MAC protocol data unit including the MAC packet, for transmitting the MPDU having a predetermined data amount, formed in the physical layer, by time-division radio transmission, between a transmitting-side transmission terminal and a receiving-side transmission terminal among a large number of transmission terminals through a local area network, wherein a part of the large number of transmission terminals uses an extended network protocol capable of forming an extended MPDU having a larger data amount than the predetermined data amount, as the network protocol, and wherein the system comprises means for, when the part of transmission terminals become the transmitting-side transmission terminal, if it is determined through the LAN that the receiving-side transmission terminal is the part of transmission terminals applicable to the extended network protocol, forming the extended MPDU in the physical layer in accordance with the extended network protocol, and transmitting the extended MPDU through the LAN to the receiving-side transmission terminal.

According to the above-described means, in a case where a part of the large number of transmission terminals is a transmitting-side transmission terminal and when the transmitting-side transmission terminal transmits an extended MPDU to the receiving-side transmission terminal through the LAN, it is examined whether or not the receiving-side transmission terminal is applicable to the extended network protocol. If it is determined that the receiving-side transmission terminal is applicable to the extended network protocol, the transmitting-side transmission terminal forms an extended MPDU, having a data amount larger than the standardized data amount in the network protocol, in the physical layer in accordance with the extended network protocol, and transmits the extended MPDU to the receiving-side transmission terminal through the LAN by radio transmission. Accordingly, the transmission rate of the LAN is improved by the increment of data amount in the extended MPDU, and the delay of packet data transmission from the transmitting-side transmission terminal to the receiving-side transmission terminal can be avoided.

In this case, when the MAC packet is formed from the IP packet, the extended network protocol in the means combines data areas of two IP packets where data amounts are reduced to some extent.

In this arrangement, an extended MPDU having data bytes substantially close to that in general two IP packets can be transmitted in one transmission, and the transmission rate of the LAN can be greatly improved.

Further, when the MAC packet is formed from the IP packet, the extended network protocol in the means forms a MAC packet including an IP packet where a data amount is reduced to some extent, and when an extended MPDU is formed from the MAC packet, combines data areas of three of the formed MAC packets.

In this arrangement, an extended MPDU having data bytes substantially close to that in general three MAC packets can be transmitted in one transmission, and the transmission rate of the LAN can be greatly improved.

Further, in the means, the transmitting-side transmission terminal as the part of transmission terminals forms extended MPDU in accordance with the extended network protocol only when a radio transmission status of the LAN is good.

In this arrangement, when an extended MPDU having a large number of data bytes is transmitted onto the LAN, as the radio transmission status of the LAN is good, the extended MPDU can be transmitted to the receiving-side transmission terminal almost without failure, and retransmission of the extended MPDU due to poor radio transmission status of the LAN can be avoided.

### BRIEF DESCRIPTION OF THE DRAWINGS

FIG. 1 is a block diagram showing principle elements of a transmission terminal used in a radio transmission system according to the present invention;

FIG. 2 is an explanatory view showing a first example of a four-layer extended network protocol utilized in the radio transmission system using the transmission terminal in FIG. 1;

FIG. 3 is a flowchart showing the operation in formation of transmission packet data by the transmission terminal in FIG. 1 in accordance with the first example of the extended network protocol;

FIG. 4 is a flowchart showing the operation in processing on received packet data by the transmission terminal in FIG. 1 in accordance with the first example of the extended network protocol;

FIG. 5 is a sequential view showing a status of delivery of various data in transmission/reception of packet data by the transmission terminal in FIG. 1 in accordance with the first example of the extended network protocol;

FIG. 6 is an explanatory view showing the second example of the four-layer extended network protocol utilized in a radio transmission system using the transmission terminal in FIG. 1;

FIG. 7 is a flowchart showing the operation in formation of transmission packet data by the transmission terminal in FIG. 1 in accordance with the second example of the extended network protocol;

FIG. 8 is a flowchart showing the operation in processing on received packet data by the transmission terminal in FIG. 1, in accordance with the second example of the extended network protocol;

FIG. 9 is a sequential view showing a status of delivery of various data in transmission/reception of packet data by the transmission terminal in FIG. 1 in accordance with the second example of the extended network protocol; and

FIG. 10 is an explanatory view showing an example of structure of the well-known three-layer network protocol used in a radio transmission system using a LAN.

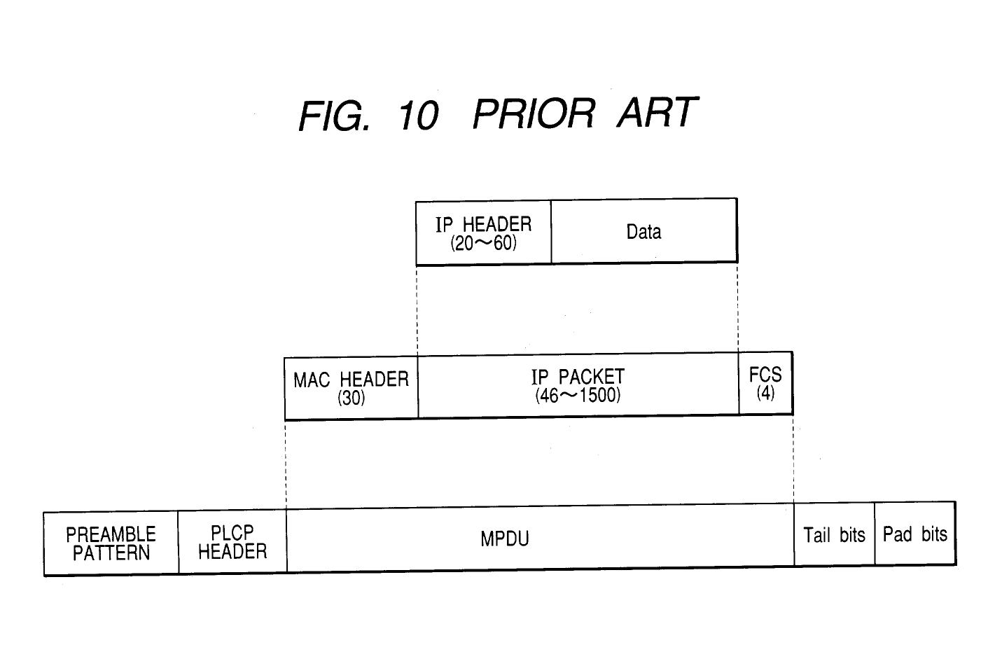

### DETAILED DESCRIPTION OF THE PREFERRED EMBODIMENT

Hereinbelow, a preferred embodiment of the present invention will be described in accordance with the accompanying drawings.

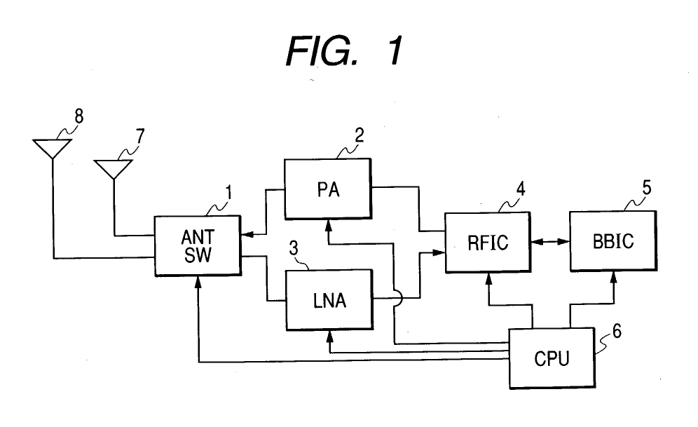

FIG. 1 is a block diagram showing principle elements of a transmission terminal used in a radio transmission system according to the present invention.

As shown in FIG. 1, the transmission terminal has an antenna switch (ANT SW) 1, a power amplifier (PA) 2, a linear amplifier (LNA) 3, a radio frequency integrated circuit (RFIC) 4, a baseband integrated circuit (BBIC) 5, a controller (CPU) 6, a transmission antenna 7 and a reception antenna 8.

Upon transmission, the antenna switch 1 connects an output terminal of the power amplifier 2 to the transmission antenna 7 under the control of the controller 6, and upon reception, connects the reception antenna 8 to an input terminal of the linear amplifier 3. The power amplifier 2, in which an input terminal is connected to an output terminal of the radio frequency integrated circuit 4, amplifies the power of a radio frequency signal which is transmitted upon transmission, under the control of the controller 6. The linear amplifier 3, in which an output terminal is connected to an input terminal of the radio frequency integrated circuit 4, linearly amplifies a radio frequency signal received upon reception, under the control of the controller 6. The radio frequency integrated circuit 4, connected to the baseband integrated circuit 5, converts a baseband signal into a radio frequency signal upon transmission, and reproduces a base band signal from a radio frequency signal upon reception, under the control of the controller 6. The baseband integrated circuit 5 forms a baseband signal to be transmitted, and performs processing on a received baseband signal, under the control of the controller 6.

In this case, as described later, the transmission terminal uses an extended network protocol in place of the general network protocol, TCP/IP (Transmission control Protocol/Internet Procotol). The transmission terminal performs data processing so as to form an extended MPDU in the physical layer in accordance with the extended network protocol.

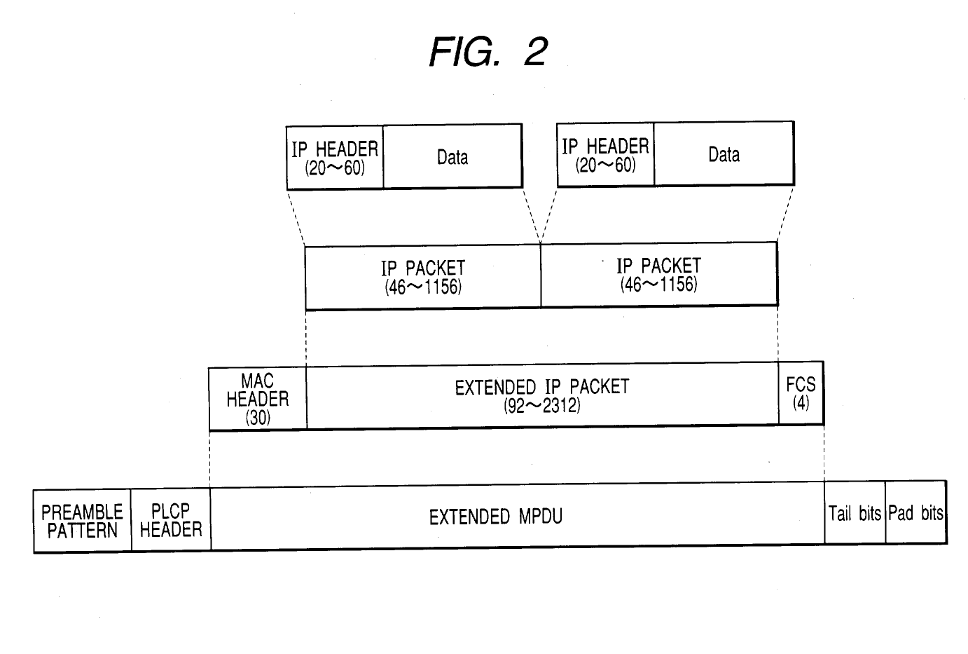

FIG. 2 is an explanatory view showing a first example of a four-layer extended network protocol utilized in a radio transmission system using the transmission terminal in FIG. 1.

As shown in FIG. 2, the extended network protocol has an IP (Internet Protocol) layer as a third layer, a MAC (Media Access Control) layer as a second layer, a physical layer as a first layer, and an intermediate layer between the third and second layers. The IP layer handles an IP packet including an IP header and a data area holding up to 1500 byte data. The intermediate layer handles an extended IP packet in which two IP packets in which the number of bytes is reduced are combined. In the combined IP packets, the maximum number of data bytes in the data area is reduced from 1500 bytes to 1156 bytes. The MAC layer handles a MAC packet including a MAC header, the above-described extended IP packet and an FCS (Frame Check Sequence). The physical layer handles packet data including a preamble pattern, a PLCP header, an extended MPDU (extended MAC protocol data unit) having the above-described MAC packet, tail bits and pad bits.

When it is determined that a receiving-side transmission terminal, as a transmission destination of packet data transmitted from the transmitting-side transmission terminal, is a transmission terminal applicable to the extended network protocol, the packet data formed as above is transmitted between the transmitting-side transmission terminal and the receiving-side transmission terminal through the LAN.

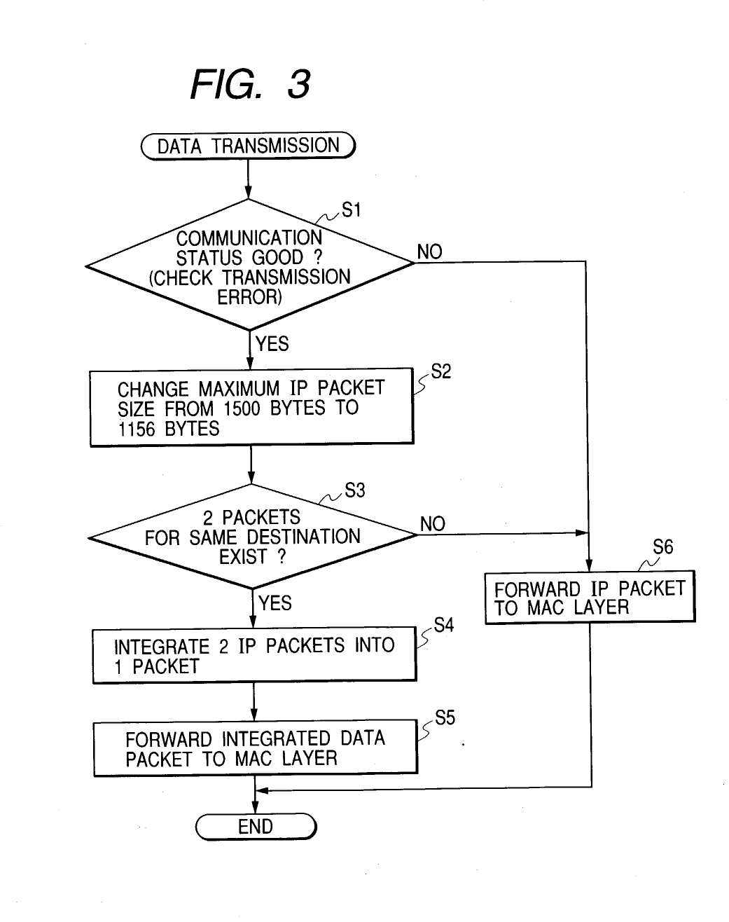

FIG. 3 is a flowchart showing the operation upon formation of transmission packet data by the transmission terminal in FIG. 1 in accordance with the first example of the extended network protocol.

The operation upon formation of the transmission packet data by the transmission terminal will be described with reference to the flowchart of FIG. 3.

First, at step S1, the controller 6 examines a data transmission status in the LAN and determines whether or not the data transmission status is good, i.e., whether or not a transmission error occurs. If it is determined that the data transmission status is good (Y), the process proceeds to step S2, on the other hand, if it is determined that the data transmission status is not good (N), the process proceeds to step S6.

Next, at step S2, the controller 6 changes the maximum number of data bytes of the data area of an IP packet in the IP layer, from 1500 bytes to 1156.

Next, at step S3, the controller 6 examines the IP packet where the number of bytes has been changed, and determines whether or not two IP packets destined for the same transmission terminal exist. If it is determined that two IP packets destined for the same transmission terminal exist (Y), the process proceeds to step S4, on the other hand, if it is determined that two IP packets destined for the same transmission terminal do not exist (N), the process proceeds to step S6.

Next, at step S4, the controller 6 combines the 2 IP packets destined for the same transmission terminal, thereby forms an extended IP packet.

Next, at step S5, the controller 6 forms a MAC packet by use of the formed extended IP packet, and further, forms packet data including the formed MAC packet as an extended MPDU. At transmission timing, the formed packet data is transmitted by radio transmission from the transmission terminal to the receiving-side transmission terminal through the LAN.

Further, at step S6, as the data transmission status is not good or two IP packets destined for the same transmission terminals do not exit, the controller 6 forms MAC packet using the respective IP packets, and further, forms packet data having the formed MAC packet as MPDUs. At transmission timing, the formed packet data is transmitted by radio transmission from the transmission terminal to the receiving-side transmission terminal through the LAN.

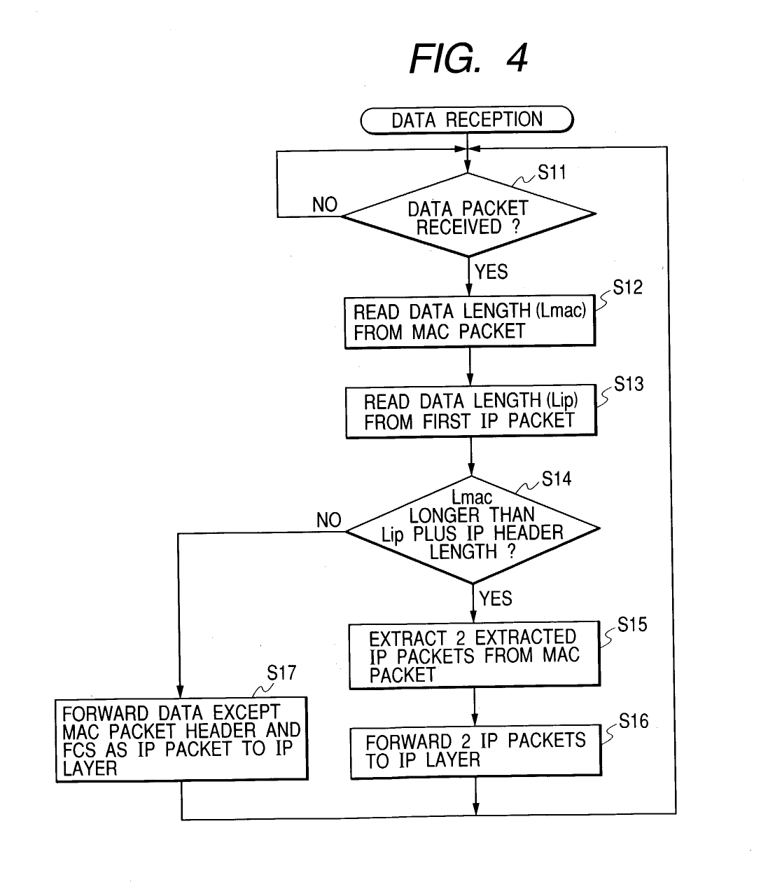

FIG. 4 is a flowchart showing the operation in processing on received packet data by the transmission terminal in FIG. 1 in accordance with the first example of the extended network protocol.

The operation in processing on the received packet data by the transmission terminal will be described with reference to the flowchart of FIG. 4.

First, at step S11, the controller 6 determines through the LAN whether or not packet data has been received from the transmitting-side transmission terminal. If it is determined that packet data has already been received (Y), the process proceeds to step S12, on the other hand, if it is determined that data packet has not been received yet (N), step S11 is repeatedly executed.

Next, at step S12, the controller 6 extracts a MAC packet from the received packet data, and detects the number of data bytes of an extended IP packet in a MAC packet, i.e., a data length (Lmac).

Next, at step S13, the controller 6 extracts a first IP packet in the extended IP packet, and detects the number of data bytes of the IP packet, i.e., a data length (Lip).

Next, at step S14, the controller 6 compares the obtained data length (Lmac) of the extended IP packet with a data length obtained by adding the IP header length to the obtained data length (Lip) of the initial IP packet, and determines whether or not the former is longer than the latter. If it is determined that the former is longer than the latter (Y), the process proceeds to step S15, on the other hand, if it is determined that the former is not longer than the latter (N), the process proceeds to step S17.

Next, at step S15, the controller 6 obtains two IP packets from the extracted MAC packet.

Next, at step S16, the controller 6 forwards the obtained two IP packets to the IP layer. When this processing has been completed, the process returns to step S11 to repeat the processing at step S11 and the subsequent steps.

Further, at step S17, the controller 6 forms an IP packet from the extracted MAC packet by removing a MAC header and an FCS (Frame Check Sequence), and forwards the obtained IP packet to the IP layer. When this processing has been completed, the process returns to step S11 to repeat the processing at step S11 and the subsequent steps.

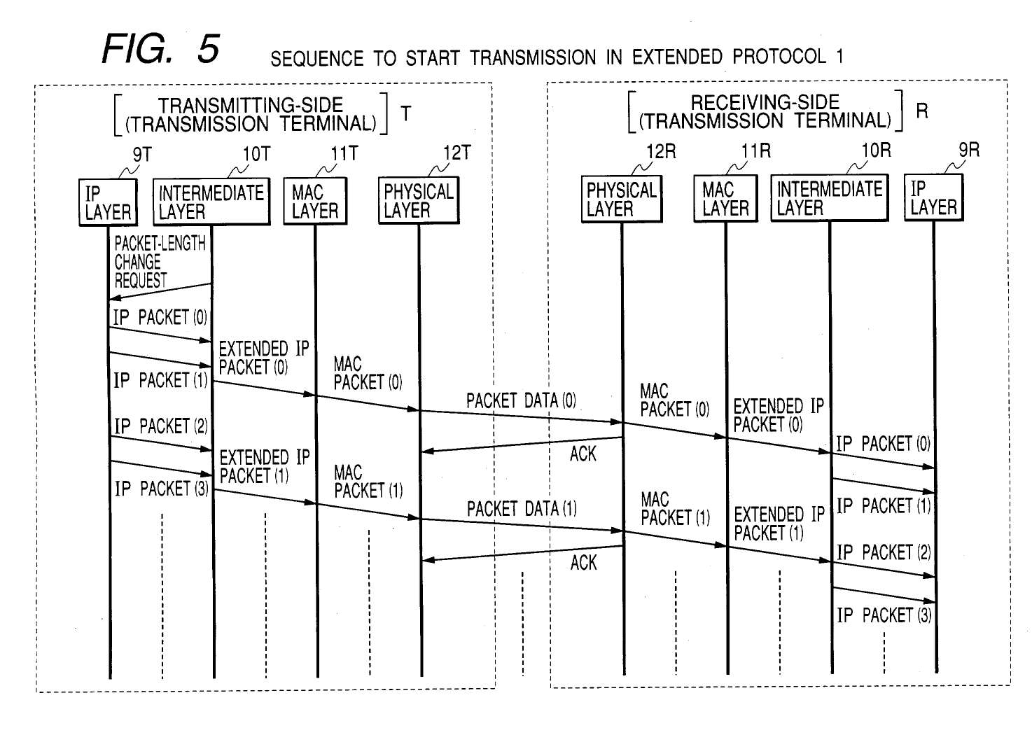

FIG. 5 is a sequential view showing a status of delivery of various data upon transmission/reception of packet data by the transmission terminal in FIG. 1 in accordance with the first example of the extended network protocol.

As shown in FIG. 5, the left side indicates a transmitting-side transmission terminal T, the right side, a receiving-side transmission terminal R. The transmitting-side transmission terminal T has an IP layer 9T, an intermediate layer 10T, a MAC layer 11T and a physical layer 12T, and the receiving-side transmission terminal R has an IP layer 9R, an intermediate layer 10R, a MAC layer 11R and a physical layer 12R.

First, the status of data delivery (operation sequence) when the transmitting-side transmission terminal T examines whether or not the receiving-side terminal R is corresponding to the first example of the extended network protocol will be described with reference to FIG. 5. Note that the operation sequence at this time is not shown in FIG. 5.

The transmitting-side transmission terminal T generates an extended network-protocol request command from the intermediate layer 10T, and transmits the request command via the MAC layer 11T to the physical layer 12T, then from the physical layer 12T to the physical layer 12R of the receiving-side transmission terminal R by radio transmission. The receiving-side transmission terminal R receives the request command and returns ACK (response information) from the physical layer 12R to the physical layer 12T of the transmitting-side transmission terminal T, and at the same time, transmits the request command via the MAC layer 11R to the intermediate layer 10R. The intermediate layer 10R, applicable to the first example of the extended network protocol, generates extended network-protocol response information, and transmits the response information via the MAC layer 11R to the physical layer 12R, the response information is transmitted from the physical layer 12R to the physical layer 12T of the transmitting-side transmission terminal T by radio transmission. The transmitting-side transmission terminal T receives the response information and returns ACK (response information) from the physical layer 12T to the physical layer 12R of the receiving-side transmission terminal R, and at the same time, transmits the response information through the MAC layer 11T to the intermediate layer 10T, thus, preparation in accordance with the first example of the extended network protocol is completed in the intermediate layer 10T.

Next, the status of deliver of various data (operation sequence) in transmission/reception by the transmission terminal in accordance with the first example of the extended network protocol will be described with reference to FIG. 5.

The transmitting-side transmission terminal T sends an IP-packet data-length change request from the intermediate layer 10T to the IP layer 9T. The IP layer 9T receives the request, and changes the number of data bytes of IP packet from maximum 1500 bytes to maximum 1156 bytes. Thereafter, the IP layer 9T transmits two IP packets (0) and (1) in which the number of data bytes has been changed to the intermediate layer 10T. The intermediate layer 10T combines the IP packets (0) and (1), thereby forms an extended IP packet (0) having up to 2312 data bytes. The intermediate layer 10T transmits the formed extended IP packet (0) to the MAC layer 11T, and the MAC layer 11T forms a MAC packet (0). The MAC layer 11T transmits the formed MAC packet (0) to the physical layer 12T, to form packet data (0). The physical layer 12T transmits the formed packet data (0) to the physical layer 12R of the receiving-side transmission terminal R by radio transmission.

The receiving-side transmission terminal R receives the packet data (0) and returns ACK (response information) from the physical layer 12R to the physical layer 12T of the transmitting-side transmission terminal T, and at the same time, changes the packet data (0) into the MAC packet (0) and transmits the MAC packet (0) into the MAC layer 11R. The MAC layer 11R changes the MAC packet (0) to the extended IP packet (0) and transmits the packet to the intermediate layer 10R. The intermediate layer 10R changes the extended IP packet (0) into the two IP packets (0) and (1), and transmits them to the IP layer 9R.

Thereafter, if further an IP packet (2) and an IP packet (3) to be transmitted from the transmitting-side transmission terminal T to the receiving-side transmission terminal R exist, they are transmitted, through the above-described processing, to the IP layer 9R of the receiving-side transmission terminal R.

Next, an operation sequence in a case where the transmitting-side transmission terminal T, in a status according to the first example of the extended network protocol, is returned to a general network protocol, will be described. Note that the operation sequence is not shown in FIG. 5.

The transmitting-side transmission terminal T sends an IP-packet data-length change request from the intermediate layer 10T to the IP layer 9T, and the IP layer 9T receives the request and changes the number of data bytes of IP packet from maximum 1156 bytes to maximum 1500 bytes. Thereafter, the IP layer 9T transmits an IP packet (0) where the number of data bytes has been changed through the intermediate layer 10T to the MAC layer 11T, and the MAC layer 11T forms a MAC packet (0). The MAC layer 11T transmits the formed MAC packet (0) to the physical layer 12T, to form packet data (0). The physical layer 12T transmits the formed packet data (0) to the physical layer 12R of the receiving-side transmission terminal R by radio transmission.

The receiving-side transmission terminal R receives the packet data (0), returns ACK (response information) from the physical layer 12R to the physical layer 12T of the transmitting-side transmission terminal T, and at the same time, changes the packet data (0) into the MAC packet (0) and transmits the MAC packet (0) to the MAC layer 11R. The MAC layer 11R changes the MAC packet (0) to the IP packet (0), and transmits the IP packet (0) through the intermediate layer 10R to the IP layer 9R.

In the above arrangement, in accordance with the first example of the extended network protocol, one extended IP packet is formed by combining two IP packets, however, it may be arranged such that one extended MPDU (extended MAC protocol data unit) is formed by combining three MAC packets, in accordance with a second example of the extended network protocol.

Hereinbelow, an example of forming one extended MPDU by combining three MAC packets in accordance with the second example of the extended network protocol will be described.

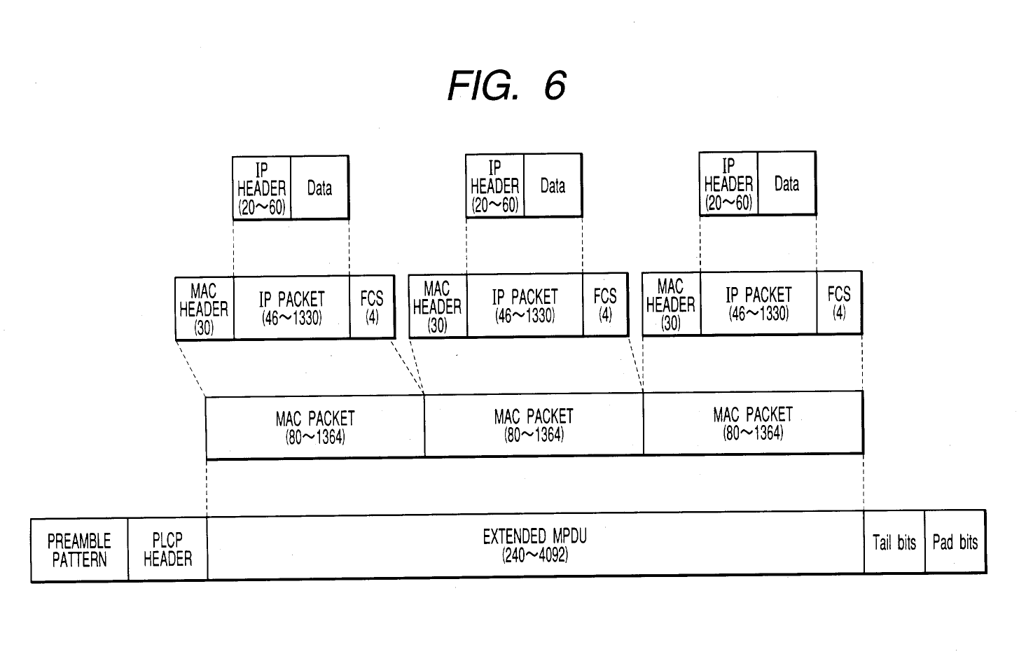

FIG. 6 is an explanatory view showing the second example of the four-layer extended network protocol utilized in a radio transmission system using the transmission terminal in FIG. 1.

As shown in FIG. 6, the extended network protocol has an IP (Internet Protocol) layer as a third layer, a MAC (Media Access Control) layer as a second layer, a physical layer as a first layer, and an intermediate layer between the second layer and the first layer. The IP layer handles an IP packet including an IP header and a data area holding up to 1500 byte data. The MAC layer handles a MAC packet including a MAC header, an IP packet in which the maximum number of data bytes of the data area is reduced from 1500 to 1330, and an FCS (Frame Check Sequence). The intermediate layer handles an extended MAC packet in which three MAC packets are combined. The physical layer handles packet data including a preamble pattern, a PLCP header, an extended MPDU (extended MAC protocol data unit) having an extended MAC packet, tail bits and pad bits.

When it has been determined that the receiving-side transmission terminal as a destination of packet data formed as above from the transmitting-side transmission terminal is applicable to the extended network protocol, the packet data is transmitted between the transmitting-side transmission terminal and the receiving-side transmission terminal through the LAN.

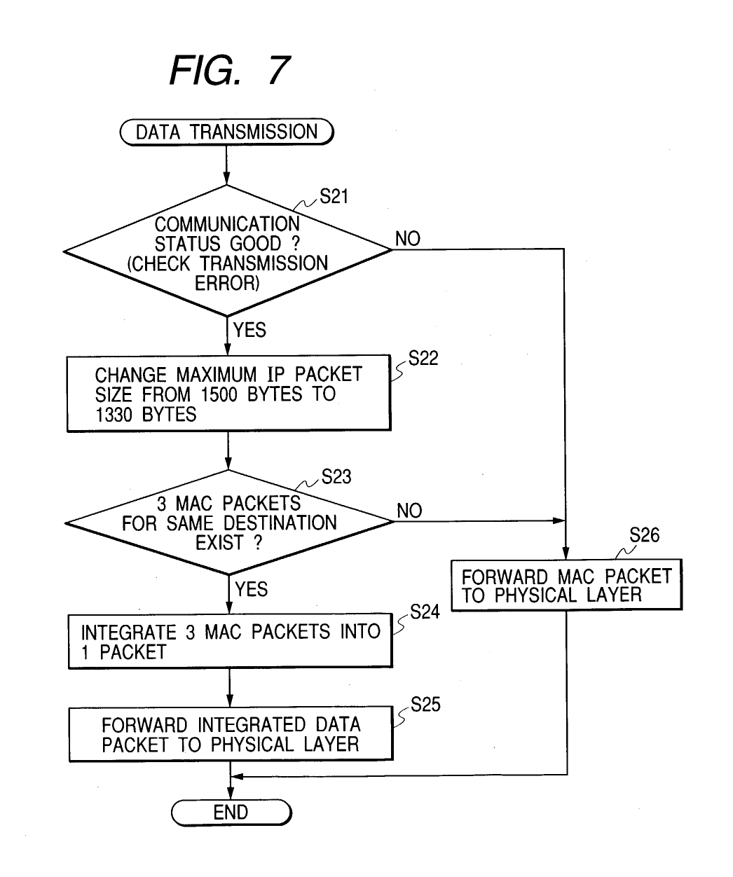

FIG. 7 is a flowchart showing the operation of forming transmission packet data by the transmission terminal in FIG. 1 in accordance with the second example of the extended network protocol.

The operation in formation of the transmission packet data by the transmission terminal will be described with reference to the flowchart of FIG. 7.

First, at step S21, the controller 6 examines a data transmission status in the LAN to determine whether or not the data transmission status is good, i.e., whether or not a transmission error occurs. If it is determined that the data transmission status is good (Y), the process proceeds to step S22, on the other hand, if it is determined that the data transmission status is not good (N), the process proceeds to step S26.

Next, at step S22, the controller 6 changes the maximum number of data bytes of the data area of an IP packet in the IP layer, from 1500 bytes to 1330 bytes, and forms a MAC packet having an IP packet where the number of bytes has been changed.

Next, at step S23, the controller 6 examines the respective MAC packets, and determines whether or not three MAC packets destined for the same transmission terminal exist. If it is determined that three MAC packets destined for the same transmission terminal exist (Y), the process proceeds to step S24, on the other hand, if it is determined that three MAC packets destined for the same transmission terminal do not exist (N), the process proceeds to step S26.

Next, at step S24, the controller 6 combines the three MAC packets destined for the same transmission terminal, thereby forms an extended MAC packet.

Next, at step S25, the controller 6 forms packet data using the formed extended MAC packet as an extended MPDU. At transmission timing, the formed packet data is transmitted by radio transmission from the transmission terminal to the receiving-side transmission terminal through the LAN.

Further, at step S26, as the data transmission status is not good or three MAC packets destined for the same transmission terminals do not exit, the controller 6 forms packet data having the respective MAC packets as MPDUs. At transmission timing, the formed packet data is transmitted by radio transmission from the transmission terminal to the receiving-side transmission terminal through the LAN.

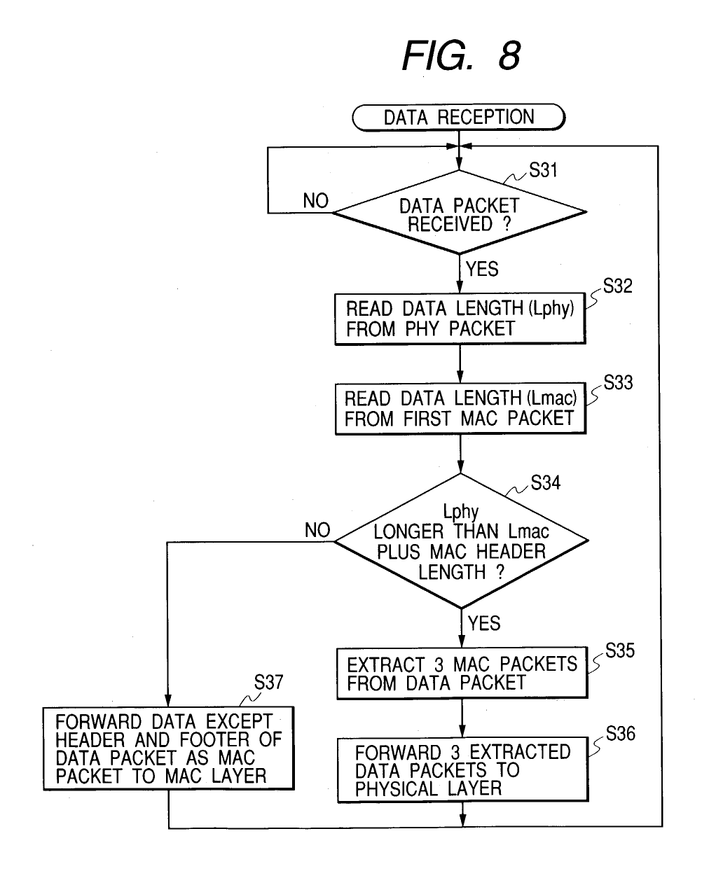

FIG. 8 is a flowchart showing the operation in processing on received packet data by the transmission terminal in FIG. 1 in accordance with the second example of the extended network protocol.

The operation in processing on the received packet data by the transmission terminal will be described with reference to the flowchart of FIG. 8.

First, at step S31, the controller 6 determines through the LAN whether or not data packet has been received from the transmitting-side transmission terminal. If it is determined that data packet has already been received (Y), the process proceeds to step S32, on the other hand, if it is determined that data packet has not been received yet (N), step S31 is repeatedly executed.

Next, at step S32, the controller 6 detects the number of data bytes of the received data packet, i.e., a data length (Lphy).

Next, at step S33, the controller 6 extracts a first MAC packet in a MAC packet, and detects the number of data bytes of the MAC packet, i.e., a data length (Lmac) Next, at step S34, the controller 6 compares the obtained data length (Lphy) of the obtained data IP packet with a data length obtained by adding the MAC header length to the obtained data length (Lmac) of the initial MAC packet, and determines whether or not the former is longer than the latter. If it is determined that the former is longer than the latter (Y), the process proceeds to step S35, on the other hand, if it is determined that the former is not longer than the latter (N), the process proceeds to step S37.

Next, at step S35, the controller 6 obtains three MAC packets from the data packet.

Next, at step S36, the controller 6 forwards the obtained 3 MAC packets to the physical layer. When this processing has been completed, the process returns to step S31 to repeat the processing at step S31 and the subsequent steps.

Further, at step S37, the controller 6 forms a MAC packet from the received data packet by removing PCLP header and footer, and forwards the obtained MAC packet to the MAC layer. When this processing has been completed, the process returns to step S31 to repeat the processing at step S31 and the subsequent steps.

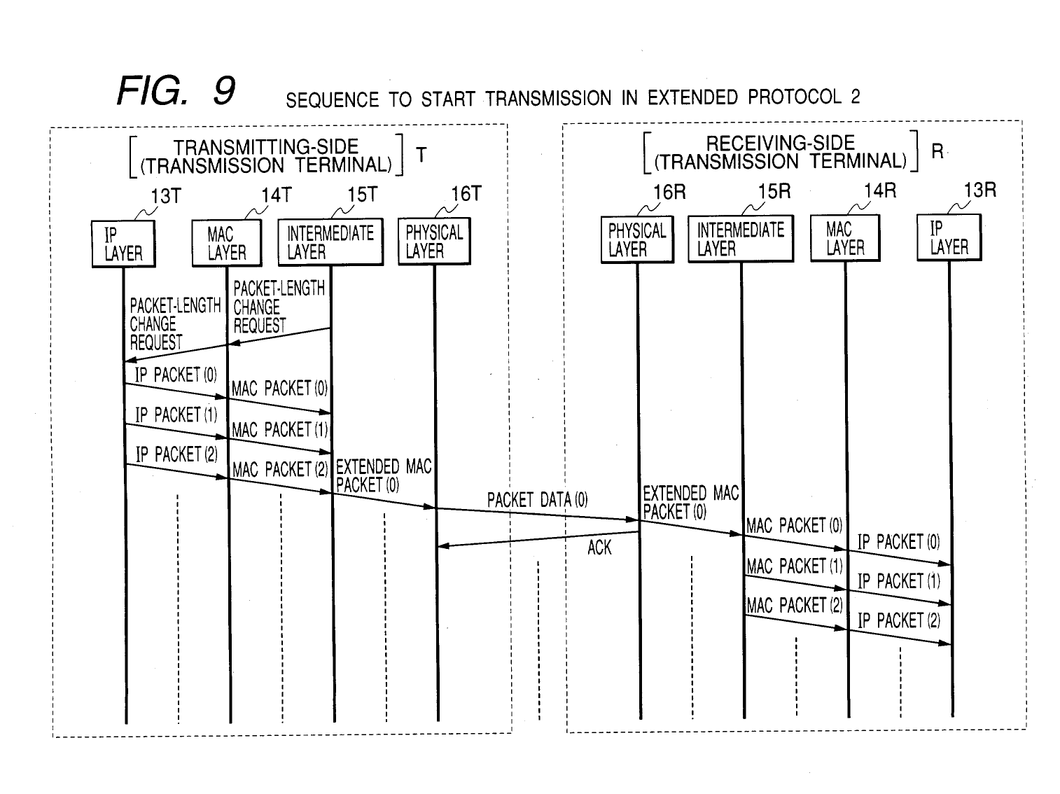

FIG. 9 is a sequential view showing a status of delivery of various data in transmission/reception of packet data by the transmission terminal in FIG. 1 in accordance with the second example of the extended network protocol.

As shown in FIG. 9, the left side indicates a transmitting-side transmission terminal T, the right side, a receiving-side transmission terminal R. The transmitting-side transmission terminal T has an IP layer 13T, a MAC layer 14T, an intermediate layer 15T and a physical layer 16T, and the receiving-side transmission terminal R has an IP layer 13R, a MAC layer 14R, an intermediate layer 15R and a physical layer 16R.

First, the status of data delivery (operation sequence) when the transmitting-side transmission terminal T examines whether or not the receiving-side terminal R is corresponding to the second example of the extended network protocol will be described with reference to FIG. 9. Note that the operation sequence at this time is not shown in FIG. 9.

The transmitting-side transmission terminal T generates an extended network-protocol request command from the intermediate layer 15T, and transmits the request command to the physical layer 16T, and from the physical layer 16T to the physical layer 16R of the receiving-side transmission terminal R by radio transmission. The receiving-side transmission terminal R receives the request command and returns ACK (response information) from the physical layer 16R to the physical layer 16T of the transmitting-side transmission terminal T, and at the same time, transmits the request command to the intermediate layer 15R. The intermediate layer 15R, applicable to the second example of the extended network protocol, generates extended network-protocol response information, and transmits the response information to the physical layer 16R, and the response information is transmitted from the physical layer 16R to the physical layer 16T of the transmitting-side transmission terminal T by radio transmission. The transmitting-side transmission terminal T receives the response information and returns ACK (response information) from the physical layer 16T to the physical layer 16R of the receiving-side transmission terminal R, and at the same time, transmits the response information to the intermediate layer 15T, thus, preparation in accordance with the second example of the extended network protocol is completed in the intermediate layer 15T.

Next, the status of deliver of various data (operation sequence) in transmission/reception of packet data by the transmission terminal in accordance with the second example of the extended network protocol will be described with reference to FIG. 9.

The transmitting-side transmission terminal T sends an IP-packet data-length change request from the intermediate layer 15T through the MAC layer 14T to the IP layer 13T. The IP layer 13T receives the request, and changes the number of data bytes of IP packet from maximum 1500 bytes to maximum 1330 bytes. Thereafter, the IP layer 13T transmits, to the MAC layer 14T, three IP packets (0), (1) and (2) in which the number of data bytes has been changed. The MAC layer 14T forms MAC packets (0), (1) and (2) corresponding to the respective IP packets (0), (1) and (2). The MAC layer 14T transmits the formed MAC packets (0), (1) and (2) to the intermediate layer 15T. The intermediate layer 15T combines these packets, thereby forms an extended MAC packet holding up to 4092 data bytes. The intermediate layer 15T transmits the formed extended MAC packet (0) to the physical layer 16T, and the physical layer 16T forms packet data (0). The physical layer 16T transmits the formed packet data (0) to the physical layer 16R of the receiving-side transmission terminal R by radio transmission.

The side-side transmission terminal R receives the packet data (0) and returns ACK (response information) from the physical layer 16R to the physical layer 16T of the transmitting-side transmission terminal T, and at the same time, changes the packet data (0) into the extended MAC packet (0) and transmits the extended MAC packet (0) to the MAC layer 15R. The MAC layer 15R changes the extended MAC packet (0) to the three MAC packets (0), (1) and (2), and transmits them to the MAC layer 14R. The MAC layer 14T changes the MAC packets (0), (1) and (2) to the corresponding IP packets (0), (1) and (2), and transmits them to the IP layer 13R.

Thereafter, if further plural IP packets to be transmitted from the transmitting-side transmission terminal T to the receiving-side transmission terminal R exist, they are transmitted, through the above-described processing, to the IP layer 13R of the receiving-side transmission terminal R.

Next, an operation sequence in a case where the transmitting-side transmission terminal T, in a status according to the second example of the extended network protocol, is returned to a general network protocol, will be described. Note that the operation sequence is not shown in FIG. 9.

The transmitting-side transmission terminal T sends an IP-packet data-length change request from the intermediate layer 15T through the MAC layer 14T to the IP layer 13T, and the IP layer 13T receives the request and changes the number of data bytes of IP packet from maximum 1330 bytes to maximum 1500 bytes. Thereafter, the IP layer 13T transmits, to the MAC layer 14T, the IP packet (0) where the number of data bytes has been changed, and the MAC layer 14T forms a MAC packet (0). The MAC layer 14T transmits the formed MAC packet (0) through the intermediate layer 15T to the physical layer 16T, to form packet data (0). The physical layer 16T transmits the formed packet data (0) to the physical layer 16R of the receiving-side transmission terminal R by radio transmission.

The receiving-side transmission terminal R receives the packet data (0), returns ACK (response information) from the physical layer 16R to the physical layer 16T of the transmitting-side transmission terminal T, and at the same time, changes the packet data (0) into the MAC packet (0) and transmits the MAC packet (0) through the MAC layer 15R to the MAC layer 14R. The MAC layer 14R changes the MAC packet (0) into the IP packet (0), and transmits the IP packet (0) to the IP layer 13R.

As described above, according to the present invention, in a case where a part of a large number of transmission terminals is a transmitting-side transmission terminal and the transmitting-side transmission terminal transmits an extended MPDU to a receiving-side transmission terminal through a LAN, it is determined whether or not the receiving-side transmission terminal is applicable to the extended network protocol. If it is determined that the receiving-side transmission terminal is applicable to the extended network protocol, the transmitting-side transmission terminal forms an extended MPDU having a data amount larger than the data amount standardized in the network protocol, in the physical layer, in accordance with the extended network protocol, and transmits the extended MPDU to the receiving-side transmission terminal through the LAN by radio transmission. Accordingly, a transmission rate of the LAN is improved by the increment of data amount by using the extended MPDU, and delay of packet data transmission from the transmitting-side transmission terminal to the receiving-side transmission terminal can be avoided.

Further, according to the present invention, an extended MPDU having data bytes substantially close to that in general two IP packets can be transmitted in one transmission, and the transmission rate of the LAN can be greatly improved.

Further, according to the present invention, an extended MPDU having data bytes substantially close to that in general three MAC packets can be transmitted in one transmission, and the transmission rate of the LAN can be greatly improved.

Further, according to the present invention, when an extended MPDU having a large number of data bytes is transmitted onto the LAN, as the radio transmission status of the LAN is good, the extended MPDU can be transmitted to the receiving-side transmission terminal almost without failure, and retransmission of the extended MPDU due to poor radio transmission status of the LAN can be avoided.

What is claimed is:

1. A radio transmission system in accordance with a network protocol forming an IP layer handling an IP packet, a MAC layer handling a MAC packet including the IP packet, and a physical layer having a MAC protocol data unit including the MAC packet, for transmitting the MAC protocol data unit having a predetermined data amount, formed in the physical layer, by time-division radio transmission, between a transmitting-side transmission terminal and a receiving-side transmission terminal among a large number of transmission terminals through a local area network,
wherein a part of the large number of transmission terminals uses an extended network protocol capable of forming an extended MAC protocol data unit having a larger data amount than the predetermined data amount, as the network protocol, and
wherein when the part of transmission terminals become the transmitting-side transmission terminal, if it is determined through the local area network that the receiving-side transmission terminal is the part of transmission terminals applicable to the extended network protocol, the transmitting-side transmission terminal forms the extended MAC protocol data unit in the physical layer in accordance with the extended network protocol, and transmits the extended MAC protocol data unit through the local area network to the receiving-side transmission terminal.

2. The radio transmission system according to claim 1, wherein, when the MAC packet is formed from the IP packet, the extended network protocol combines data areas of two IP packets where data amounts are reduced to some extent.

3. The radio transmission system according to claim 1, wherein, when the MAC packet is formed from the IP packet, the extended network protocol forms a MAC packet including an IP packet where a data amount is reduced to some extent, and when the extended MAC protocol data unit is formed from the MAC packet, combines data areas of three of the formed MAC packets.

4. The radio transmission system according to claim 1, wherein the transmitting-side transmission terminal as the part of transmission terminals forms the extended MAC protocol data unit in accordance with the extended network protocol only when a radio transmission status of the local area network is good.
